(19) United States
(12) Patent Application Publication
(10) Pub. No.: US 2025/0291958 A1
(43) Pub. Date: Sep. 18, 2025

(54) Techniques For Masking Mutable Fields During Transmission And Receipt Of Packets

(71) Applicant: Altera Corporation, San Jose, CA (US)

(72) Inventors: Rajkumar Kadam, Bengaluru (IN); Raghucharan Boddupalli, Bengaluru (IN)

(73) Assignee: Altera Corporation, San Jose, CA (US)

(21) Appl. No.: 18/608,233

(22) Filed: Mar. 18, 2024

(51) Int. Cl. G06F 21/72; G06F 21/64; H04J 3/06

(52) U.S. Cl. CPC G06F 21/72; G06F 21/64; H04J 3/0667

(57) ABSTRACT

A transmitter circuit includes a security circuit that masks mutable fields in a packet during an algorithm that generates an authentication tag for the packet, an extraction circuit that extracts the mutable fields from the packet to generate extracted fields, a calculation circuit that calculates updated values for the mutable fields using the extracted fields, and an inserter circuit that inserts the updated values for the mutable fields into the packet.

### TECHNICAL FIELD

The present disclosure relates to electronic circuits, and more particularly, to techniques for masking mutable fields during the transmission and receipt of packets, such as Media Access Control security (MACsec) packets, protected for integrity by post additional authentication data (AAD) processing.

### BACKGROUND

Configurable integrated circuits (ICs) can be configured by users to implement desired custom logic functions. In a typical scenario, a logic designer uses computer-aided design (CAD) tools to design a custom circuit design. When the design process is complete, the computer-aided design tools generate configuration data. The configuration data is then loaded into configuration memory elements that configure configurable logic circuits in the integrated circuit to perform the functions of the custom circuit design.

### BRIEF DESCRIPTION OF DRAWINGS

FIG. 1A is a diagram that illustrates single step PTP.

FIG. 1B is a diagram that illustrates two step PTP.

FIG. 1C is a diagram that illustrates an example of a transmitter circuit that can transmit and process Precision Time Protocol (PTP) packets according to various techniques disclosed herein.

FIG. 1D is a diagram that illustrates an example of a receiver circuit that can receive and process PTP packets according to various techniques disclosed herein.

FIG. 2 is a diagram that illustrates examples of circuitry in the transmitter circuit of FIG. 1C.

FIG. 3 is a flow chart that illustrates examples of operations that can be performed in the transmitter circuit to process PTP packets for Media Access Control security (MACsec) according to an Advanced Encryption Standard in Galois/Counter Mode (AES-GCM) algorithm.

FIG. 4 is a flow chart that illustrates examples of operations that can be performed in the receiver circuit to process secure PTP packets for MACsec according to an AES-GCM algorithm.

FIG. 5 is a diagram that illustrates an example of a configurable logic integrated circuit (IC) that can include circuitry and algorithms disclosed herein with respect to any of FIGS. 1C-1D, 2, 3, or 4.

FIG. 6A illustrates a block diagram of a system that can be used to implement a circuit design to be programmed onto a programmable logic device using design software.

FIG. 6B is a diagram that depicts an example of a programmable logic device that includes three fabric die and two base die that are connected to one another via microbumps.

FIG. 7 is a block diagram illustrating a computing system configured to implement one or more aspects of the embodiments disclosed herein.

### DETAILED DESCRIPTION

The IEEE 1588 Precision Time Protocol (PTP) standard provides time synchronization up to nanosecond level accuracy using Global Positioning Satellite (GPS) or an atomic clock as a time reference. The PTP protocol as defined by the IEEE 1588 standard is widely implemented by time sensitive applications, such as industrial automation, mobile front haul communication, smart energy systems, and financial systems, including high frequency trading.

The PTP protocol was inherently defined with AUTHENTICATION TLV (type, length, value) for security as an optional feature and this resulted in wide deployments of unsecured time synchronization solutions that were highly vulnerable to attacks that can compromise a PTP network and result in severe consequences. The three major protocols that are deployed in networks for security at different Open Systems Interconnect (OSI) layers are Media Access Control (MAC) security in Layer 2, Internet Protocol security (IPsec) in Layer 3, and Transport layer security (TLS) in Layer 4.

PTP packets can be sent over UDP (User Datagram Protocol) or over an Ethernet layer. MAC security (MACsec) in Layer 2 is typically used for PTP security, as MACsec is a hop-by-hop security allowing intermediate nodes, such as transparent clocks to modify the correction field and update the checksum before the PTP packets are forwarded in the network.

The PTP IEEE 1588-2019 standard includes an optional mechanism for protecting the integrity of PTP packets, but this mechanism does not meet all security requirements, as key management is not defined. MACsec can cause degradation in the quality of the time transfer of packets, because calculating the timestamp at the MACsec stage is difficult, without degradation of the PTP accuracy, as the packets undergo variable latency due to MACsec and MAC processing stages. IEEE 802.1AE (MACsec) is defined to protect ethernet traffic along with IEEE 802.1X (MKA) to provide authentication and cryptographic key distribution. Thus, enabling MACsec security for PTP packets would be beneficial, as the existing MACsec infrastructure can be reused, including key management.

The two major deployments of PTP include single step PTP and two step PTP. Two step PTP involves sending an accurate timestamp of a Sync message in a follow-up message. Two step PTP is mostly handled in software, and increases software complexity and processing requirements. Customers often desire single step PTP, where the timestamp is carried in a Sync message and is usually done by hardware methods. Secure PTP with MACsec is commonly used to achieve synchronization to the Grand Master Clock within nanosecond accuracy for critical applications. Because of the variable latency involved in MACsec packet processing and parts of MAC processing, deployments often support PTP with MACsec using two step PTP methods only or single step PTP with degradation in PTP accuracy.

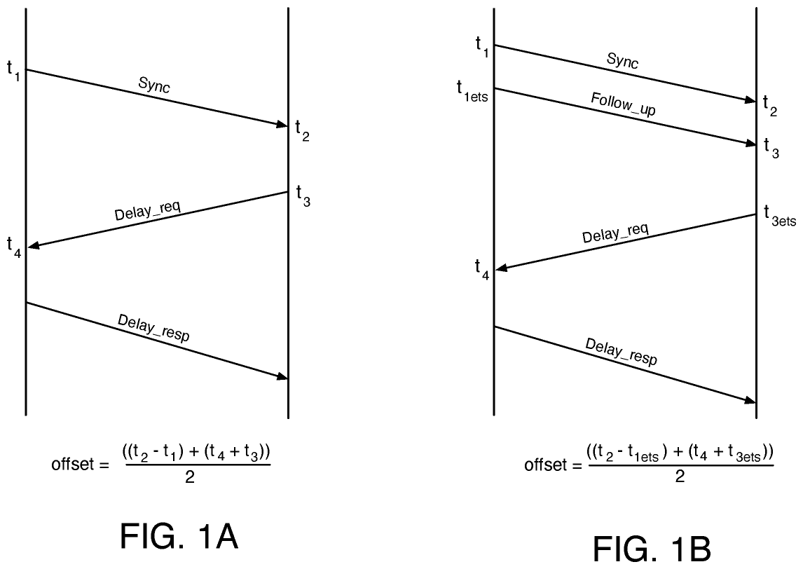

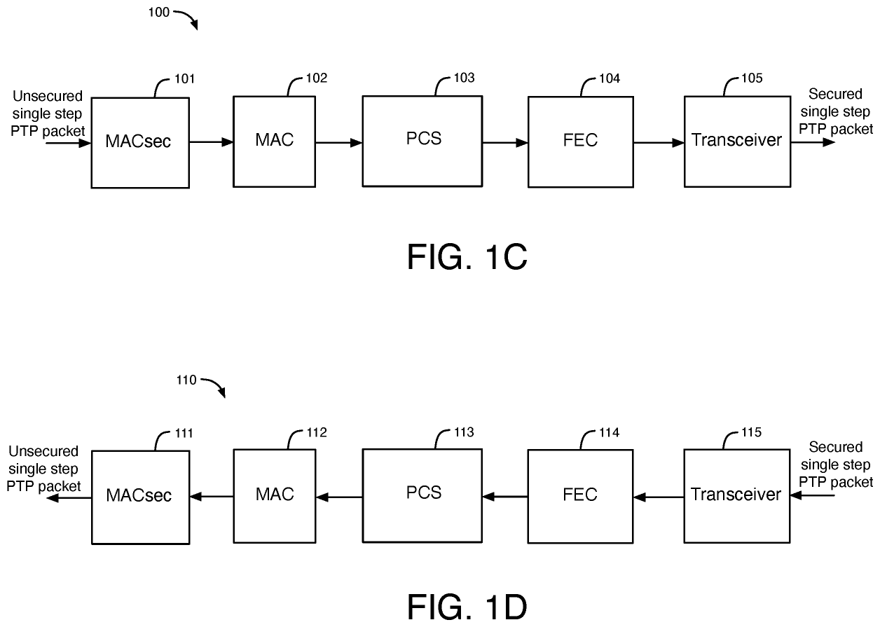

FIG. 1A is a diagram that illustrates single step PTP. A PTP Sync packet is generated in logic circuitry at time t₁ along with a fingerprint for that packet. The packet is encrypted by the MACsec logic and then sent to the MAC. When the PTP Sync packet is sent out of the MAC, the timestamp t₁ is noted. The PTP Sync packet is received at time t₂. FIG. 1A also shows the Delay_req message, which is sent at time t₃ and received at time t₄. In addition, FIG. 1A shows the Delay_resp message. The equation for the offset in single step PTP is shown in FIG. 1A.

FIG. 1B is a diagram that illustrates two step PTP. In order to calculate accurate PTP timestamps with the two step approach, a PTP Sync packet is generated in logic circuitry at time t₁ along with a fingerprint for that packet. The packet is encrypted by the MACsec logic and then sent to the MAC. When the PTP Sync packet is sent out of the MAC, the timestamp t₁ is noted. The PTP Sync packet is received at time t₂. Because the output of the MAC to the output of the physical medium attachment (PMA) sublayer is a deterministic latency, the exact time t₁ at which the Sync packet is transmitted is noted and sent back to the logic circuitry with the fingerprint. As a second step, the logic circuitry puts this timestamp t₁ in the follow-up packet and sends the follow-up packet to hard logic at time t₁ₑₜₛ, which then gets encrypted and transmitted. The follow-up packet is received at time t₃. FIG. 1B also shows the Delay_req message, which is sent at time t₃ₑₜₛ and received at time t₄. In addition, FIG. 1B shows the Delay_resp message. The equation for the offset in two step PTP is shown in FIG. 1B.

Although the two step method generates accurate timestamps, this method has software overhead. Applications such as banking and trading, smart energy deployment, and mobile front haul communications now enforce using single step PTP approaches to reduce latency and get accurate timestamps as quick as possible. Single step PTP with MACsec is slowly becoming necessary. The two step method also implies using soft logic implementations such as per port direct memory access (DMA) and buffering for fingerprint timestamp analysis.

According to some examples disclosed herein, techniques are provided for securing Precision Time Protocol (PTP) packets using MAC security (MACsec) with one or more of three modifications. The first modification involves masking and bypassing PTP mutable fields in a transmitter during processing using Advanced Encryption Standard in Galois/Counter Mode (AES-GCM). The second modification involves updating integrity check value (ICV) tags after the PTP mutable fields have been modified in the transmitter in a stage added after the Additional Authenticated Data (AAD). The third modification involves masking and bypassing the PTP mutable fields in a receiver during AES-GCM processing and the addition of a stage after AAD for ICV validation. These modifications allow PTP implementations to secure PTP packets, while retaining the supported PTP accuracy.

The PTP mutable fields are masked off during MACsec processing for both confidentiality and integrity calculation. The masked PTP mutable fields are later processed as part of the post AAD stage, and the ICV is updated in the MACsec packet on transmit and validated on receive. These techniques are flexible, configurable, and scalable to support securing PTP packets using single step PTP timestamping or any other protocol requiring modification of fields in MACsec packets which are to be protected for integrity.

These techniques can secure PTP packets using MACsec without loss of PTP accuracy by adding the three modifications in the MACsec AES-GCM processing and an additional hardware stage in the transmitter, as described above. These techniques can be applied when MACsec is used in integrity protection mode and in confidentiality protection mode. Mutable field offsets for PTP packets are fixed for a given PTP packet type. The PTP packet types for example include PTP over Ethernet with a virtual local area network (VLAN) tag, PTP over Internet Protocol version 4 (IPv4)/UDP with a VLAN tag, PTP over Internet Protocol version 6 (IPv6)/UDP with a VLAN tag, PTP over Ethernet without a VLAN tag, PTP over IPv4/UDP without a VLAN tag, PTP over IPv6/UDP without a VLAN tag, PTP over Ethernet with a stacked VLAN tag, PTP over IPv4/UDP with a stacked VLAN tag, and PTP over IPv6/UDP with a stacked VLAN tag and others.

The MACsec Key Agreement protocol (MKA) is responsible for setting up different Secure Connections (SC) for PTP packet types and other Ethernet traffic carried over the Ethernet port. PTP mutable field offsets can be stored as part of the Secure Association Database (SAD) to aid the PTP packet processing by MACsec circuitry.

One or more specific examples are described below. To provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs). As discussed herein, an integrated circuit (IC) can include hard logic and/or soft logic. The circuits in an integrated circuit device (e.g., in a configurable logic IC) that are configurable by an end user are referred to as “soft logic.” “Hard logic” generally refers to circuits in an integrated circuit device that have substantially less configurable features than soft logic or no configurable features.

FIG. 1C is a diagram that illustrates an example of a transmitter circuit 100 that can transmit and process PTP packets according to various techniques disclosed herein. The transmitter circuit 100 of FIG. (FIG.) 1C includes Media Access Control security (MACsec) circuit 101, Media Access Control (MAC) circuit 102, Physical Coding Sublayer (PCS) circuit 103, Forward Error Correction (FEC) circuit 104, and transceiver circuit 105. The PTP mutable fields include the UDP (User Datagram Protocol) Checksum, Extended Bytes for Internet Protocol version 6 (IPv6) packets, the PTP Correction Field, and the PTP Timestamp field. The transmitter circuit 100 can be fabricated in any type of integrated circuit, such as a configurable IC (e.g., a field programmable gate array (FPGA) or programmable logic device), a microprocessor IC, a graphics processing unit IC, a memory IC, an application specific IC, a transceiver IC, etc.

The MACsec circuit 101 receives unsecured single step PTP packets. The MACsec circuit 101 processes each received unsecured single step PTP packet based on the Secure Connection Identifier (SCI) setup by key management, masking the PTP mutable fields for both confidentiality and integrity (if enabled). The MAC circuit 102 performs PTP packet related processing at the same stage with or without MACsec processing, including generating modified PTP mutable fields, ensuring that the PTP packet accuracy is not affected by the MACsec processing. The modified PTP mutable fields are processed by a post Additional Authenticated Data (AAD) processing stage having deterministic latency. The integrity check value (ICV) tag is updated in the post AAD processing stage using the algorithm for AAD processing defined by the MACsec standard protecting integrity of the modified packet. Additional processing of the PTP packets is performed by the PCS circuit 103. The secured PTP packets are encoded by FEC circuit 104 using forward error correction encoding. The PTP packets are then transmitted through a network by transceiver circuit 105 as secured single step PTP packets.

FIG. 1D is a diagram that illustrates an example of a receiver circuit 110 that can receive and process PTP packets according to various techniques disclosed herein. The receiver circuit 110 of FIG. (FIG.) 1D includes Media Access Control security (MACsec) circuit 111, Media Access Control (MAC) circuit 112, Physical Coding Sublayer (PCS) circuit 113, Forward Error Correction (FEC) circuit 114, and transceiver circuit 115. The transceiver circuit 115 receives secured single step PTP packets from a network. Each incoming secured single step PTP packet is received by the transceiver circuit 115 and processed by FEC circuit 114 (i.e., to perform forward error correction decoding), PCS circuit 113 (i.e., to perform functions of the Physical Coding Sublayer), and the MAC circuit 112 (i.e., to perform functions of Media Access Control). The receiver circuit 110 can be fabricated in any type of integrated circuit (IC), such as a configurable IC (e.g., an FPGA or programmable logic device), a microprocessor IC, a graphics processing unit IC, a memory IC, an application specific IC, a transceiver IC, etc.

Each PTP packet is then processed based on the Secure Connection Identifier (SCI) setup by the key management in the MACsec circuit 111. The mutable field offsets derived from the Secure Association Database (SAD) are used to mask and bypass mutable fields for decryption (if enabled) and ICV validation in the AES-GCM algorithm in MACsec circuit 111. The AES-GCM algorithm in MACsec circuit 111 includes a post Additional Authenticated Data (AAD) processing stage that processes the PTP mutable fields. The post AAD processing stage implements the algorithm specified in the MACsec standard for AAD (additional authentication data) using the PTP packets. The calculated final ICV tag is compared to the incoming ICV tag to declare a PASS/FAIL condition for validation of the received PTP packets. The MACsec circuit 111 outputs the PTP packets as unsecured single step PTP packets.

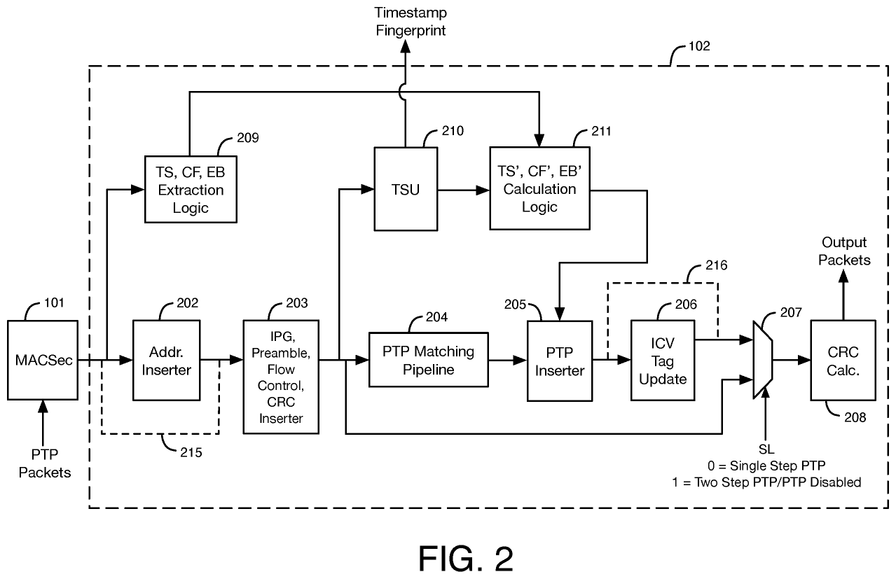

FIG. 2 is a diagram that illustrates the MACsec circuit 101 and a detailed example of the MAC circuit 102 of FIG. 1C. In the example of FIG. 2, the MAC circuit 102 includes an address (addr.) inserter circuit 202, an IPG, Preamble, Flow control, CRC inserter circuit 203, a PTP matching pipeline stage circuit 204, a PTP inserter circuit 205, an ICV tag update circuit 206, a multiplexer circuit 207, a cyclic redundancy check (CRC) calculation circuit 208, a TS, CF, EB extraction logic circuit 209, a timestamp unit (TSU) circuit 210, and a TS′, CF′, EB′ calculation logic circuit 211.

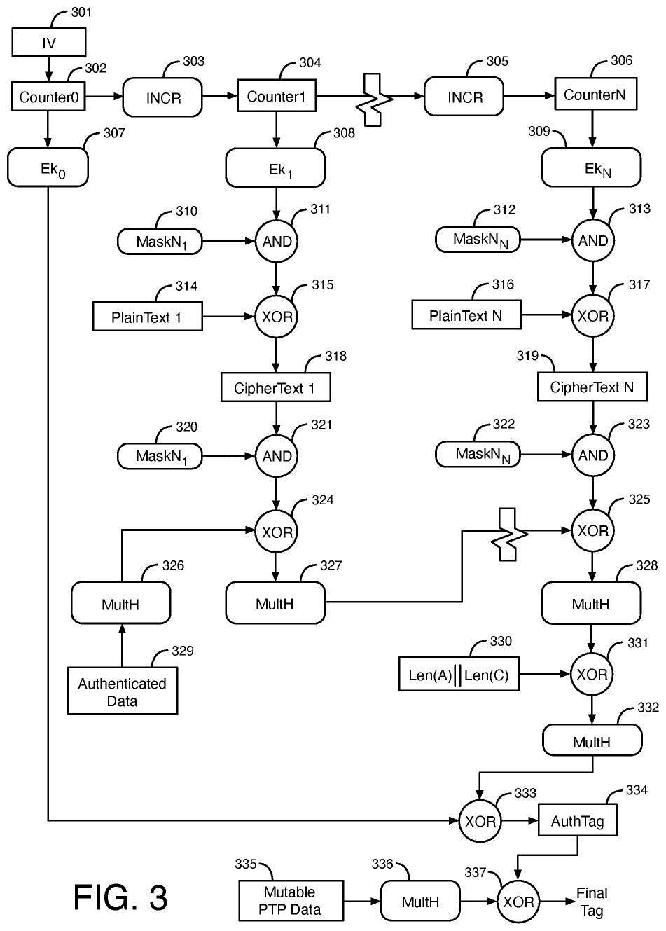

The MACsec circuit 101 receives unsecured PTP packets. The MACsec circuit 101 processes each received unsecured PTP packet based on the Secure Connection Identifier (SCI) setup by key management, skipping the PTP mutable fields for both confidentiality and integrity (if enabled). The MACsec circuit 101 masks the PTP mutable fields in the PTP packets to generate authentication tags for the PTP packets, as disclosed in further detail herein with respect to FIG. 3. The authentication tag is a cryptographic hash on data that is designed to reveal both accidental errors and the intentional modification of the data, thus protecting integrity of the data.

The PTP packets with the authentication tags are provided as MACsec packets to address inserter circuit 202 and to TS, CF, EB extraction logic circuit 209. Address inserter circuit 202 inserts source and destination MAC addresses for the PTP packets into the MACsec packets. The address inserter circuit 202 can optionally be bypassed along path 215. IPG, Preamble, Flow control, CRC inserter circuit 203 then inserts IPG (Inter Packet Gap), preamble, flow control bits and space for cycle redundancy check (CRC, if enabled) into the MACsec packets generated by and received from address inserter circuit 202. The MACsec packets generated by the inserter circuit 203 are provided to the PTP matching pipeline stage circuit 204. This PTP matching pipeline stage circuit 204 ensures that the packet data is delayed until the PTP calculation is performed in parallel for the PTP modified fields to be inserted in the packet.

The TSU circuit 210 generates timestamps for the MACsec packets using the local clock synchronized to master clock or GPS/Atomic Clock. TSU circuit 210 provides the egress timestamps to the TS′, CF′, EB′ calculation logic circuit 211. The TSU circuit 210 can also provide an egress timestamp fingerprint to a user if the fingerprint came along with the packet for tracking the packet. The TS, CF, EB extraction logic circuit 209 extracts the PTP mutable fields (e.g., a Checksum field for UDP packets and/or correction Field (CF), Timestamp (TS), and Extended Bytes (EB) fields for PTP packets) from the MACsec packets received from MACsec circuit 101 and then provides the extracted mutable fields to the TS′, CF′, EB′ calculation logic circuit 211. The TS′, CF′, EB′ calculation logic circuit 211 then uses the extracted mutable fields and/or the egress timestamps to calculate updated values for the PTP mutable fields in the UDP/PTP packets within the MACsec packets. As examples, the TS′, CF′, EB′ calculation logic circuit 211 can calculate updated values for the Checksum field for UDP packets and/or the correction Field (CF′), Timestamp (TS′), and Extended Bytes (EB′) fields (IPv6) for PTP packets using the extracted mutable fields. The TS′, CF′, EB′ calculation logic circuit 211 then provides the updated values for the PTP mutable fields to the PTP inserter circuit 205.

The PTP inserter circuit 205 inserts the updated values for the PTP mutable fields that are received from the TS′, CF′, EB′ calculation logic circuit 211 into the MACsec/Unsecured packets received from PTP matching pipeline circuit 204. The MACsec/Unsecured packets with the updated PTP mutable fields are then provided to the ICV tag update circuit 206. ICV tag update circuit 206 then inserts updated integrity check value (ICV) tags into the MACsec packets. The ICV tag update circuit 206 is bypassed through path 216 if MACsec processing is disabled for the packet. Either an updated MACsec packet with ICV tags or the Unsecured packet is provided to inputs of multiplexer circuit 207.

Multiplexer circuit 207 can be configured by the select signal SL to cause the MAC circuit 102 to operate according to single step PTP or two step PTP/PTP disabled mode. If the select signal SL is set to a first value (e.g., 1), multiplexer circuit 207 provides the MACsec/Unsecured packets output by IPG, Preamble, Flow control, CRC inserter circuit 203 directly to CRC calculation circuit 208 to cause the MAC circuit 102 to operate according to two step PTP or PTP is disabled. If the select signal SL is set to a second value (e.g., 0), PTP inserter circuit 205 provides the MACsec/Unsecured packets either via ICV tag circuit 206 or directly to multiplexer circuit 207 to cause the MAC circuit 102 to operate according to single step PTP. The output of multiplexer circuit 207 is provided to CRC calculation circuit 208. The CRC calculation circuit 208 calculates cyclic redundancy check (CRC) values and inserts the CRC values into the MACsec/Unsecured packets received from multiplexer circuit 207 to generate output packets for transmission through a network.

FIG. 3 is a flow chart that illustrates examples of operations that can be performed in the transmitter circuit 100 to process PTP packets for MACsec according to an AES-GCM algorithm. The operations of FIG. 3 can be performed, for example, by the MACsec circuit 101 in transmitter circuit 100. The MACsec circuit 101 includes logic that performs an Advanced Encryption Standard in Galois/Counter Mode (AES-GCM) algorithm that implements the operations of FIG. 3. The post AAD stage can be implemented as part of the MAC transmit stage (e.g., in ICV tag update stage 206) after the PTP field modification to protect the updated PTP mutable fields for integrity.

The AES-GCM algorithm performed by MACsec circuit 101 provides both data integrity and confidentiality to the MACsec packets. The AES-GCM algorithm receives as input a key K and plaintext P. The AES-GCM algorithm then encrypts the plaintext P using the key K to produce ciphertext C, and computes an authentication tag T from the ciphertext C and the additional authentication data (AAD). Then, an unencrypted ICV tag is inserted in the MACsec packet. A recipient with knowledge of K, upon receipt of the MACsec packet, can decrypt the ciphertext C to recover the plaintext P and can check the tag T to ensure that neither the ciphertext C nor the data protected by the ICV tag were tampered with. The AES-GCM algorithm uses a block cipher with block size of 128 bits, operates in a counter mode for encryption, and uses arithmetic in the Galois field GF (2128) to compute the authentication tag T. Galois Message Authentication Code (GMAC) is an authentication-only variant of the GCM that can form an incremental message authentication code. Both GCM and GMAC can accept initialization vectors of arbitrary length. GCM can take full advantage of parallel processing, and implementing GCM can make efficient use of an instruction pipeline or a hardware pipeline.

Referring to FIG. 3, an initialization vector (IV) 301 is provided as an input to the AES-GCM algorithm. The operations of FIG. 3 perform a block cipher operation in a counter mode. In the counter mode, an initial counter block 302 is generated from the initialization vector (IV) 301, and incrementing (INCR) functions 303 and 305 are iterated on the initial counter block 302 to generate a sequence of counter blocks 304 and 306, respectively. The counter block 302 is the first counter block of the sequence. The counter blocks are numbered sequentially. The counter blocks 302, 304, and 306 are encrypted with a block cipher (i.e., using AES-GCM) at operations 307, 308, and 309, respectively, to generate encrypted blocks (Ek₀-Ek_{N}), which are XORed with the plaintext to generate cipher text and the ICV, as shown in the FIG. 3.

Subsequently, a bitwise AND Boolean function 311 is performed on the encrypted block Ek₁ and a mask value MaskN₁ 310 (i.e., all zeros, for bits to be masked) to generate a Ciphertext 1 output 318, bypassing the PTP mutable field bits from being encrypted. Similar processes are carried out to mask any modification to other PTP mutable field bits in the packet during encryption for required blocks of data as shown in FIG. 3 in subsequent processing stages of the packet. For example, a bitwise AND Boolean function 313 is performed on the encrypted block Ek_{N} and a mask value MaskN_{N} 312 (i.e., all zeros, for bits to be masked) to generate a Ciphertext N output 319, bypassing the PTP mutable field bits from being encrypted.

Plaintext that is part of a PTP packet is input to the MACsec circuit 101. The plaintext is partitioned into a sequence of 128 bit blocks, including PlainText 1 314 to PlainText N 316. The PTP mutable field bits that are part of the PlainText 1 314 and the PlainText N 316 are masked by XOR Boolean operations 315 and 317 and the AND operations 321 and 323, respectively, prior to being processed by GHASH logic, as shown in FIG. 3. The authentication mechanism within GCM is based on a hash function, referred to as GHASH, that features multiplication by a fixed parameter, called the hash subkey, within a binary Galois field. This ensures that the PTP mutable field bits are unchanged by the AES-GCM algorithm at this stage of MACsec processing and can be modified by PTP logic later to update the relevant PTP fields according to PTP protocol requirements and later integrity protected by adding a post AAD stage, as shown in FIG. 3 by operations 335, 336, and 337.

Bitwise AND functions 311 and 313 ensure that PlainText and Ciphertext of the masked bits are exact copies, and that no modification is applied to the PlainText. Subsequently, bitwise AND Boolean functions 321 and 323 are performed on the ciphertext CipherText 1 318 and CipherText N 319 and mask values MaskN₁ 320 and MaskN_{N} 322 (i.e., all zeros for field bits to be masked), respectively, to generate an input to the GHASH algorithm, which consists of value 0 for all the field bits that are masked for processing.

In operation 326, authenticated data 329 is multiplied with a key-dependent constant H (i.e., H=CIPH_{K} (0¹²⁸)) in the Galois field GF (2¹²⁸) to generate an output. A bitwise XOR Boolean logic function 324 is then performed on the output of the multiplication performed in operation 326 and the AND Boolean function 321 to generate an output. In operation 327, the output of the bitwise XOR logic function 324 is multiplied with the key-dependent constant H in the Galois field GF (2¹²⁸) to generate an output. A bitwise XOR Boolean logic function 325 is then performed on the output of the multiplication performed in operation 327 and the AND Boolean function 323 to generate an output. The masking functions performed by AND Boolean functions 321 and 323 using mask values MaskN₁ 320 and MaskN_{N} 322 only mask CipherText 1 318 and CipherText N 319, respectively, to feed all zeros for the required mutable field bits for the purposes of the processing operations performed by the AES-GCM algorithm of FIG. 3 to avoid the outputs of operations 327-328 being modified by XOR Boolean logic functions 324-325 for specific bit locations. The mask values 320/322 and the AND functions 321/323 ensure that PTP mutable field bits are provided as value 0 to the GHASH processing operations shown in FIG. 3.

In operation 328, the output of the bitwise XOR function 325 is multiplied with the key-dependent constant H in the Galois field GF (2128) to generate an output. In FIG. 3, Len(A) and Len(C) are the 64-bit representations of the bit lengths of A and C, respectively, where A refers to data that is only authenticated and not encrypted (e.g., data 329), and C refers to the ciphertext (including the PTP mutable fields). Len(A)∥Len(C) denotes a concatenated string 330 of bit strings representing the bit length of A and the bit length of C. A bitwise XOR Boolean logic function 331 is performed on the output of the multiplication performed in operation 328 and the concatenated string 330 of bit strings Len(A)∥Len(C) to generate an output. In operation 332, the output of the bitwise XOR logic function 331 is multiplied with the key-dependent constant H in the Galois field GF (2¹²⁸) to generate an output. A bitwise XOR Boolean logic function 333 is then performed on the output of the multiplication performed in operation 332 and the encrypted block Ek₀ generated in operation 307 to generate an Authentication Tag 334 (AuthTag).

The MAC circuit 102 receives mutable PTP data 335 (e.g., a PTP field extracted from a PTP packet). In operation 336, the mutable PTP data 335 is multiplied with the key-dependent constant H in the Galois field GF (2¹²⁸) to generate an output. A bitwise XOR Boolean logic function 337 is then performed on the output of the multiplication performed in operation 336 and the Authentication Tag 334 to generate a Final Authentication Tag that the MAC circuit 102 outputs as part of the MAC packet. Operations 336-337 can, alternatively, be performed by the ICV tag update circuit 206 to insert updated integrity check value (ICV) tags (including, e.g., the Tag generated in operation 337) into the MACsec packets.

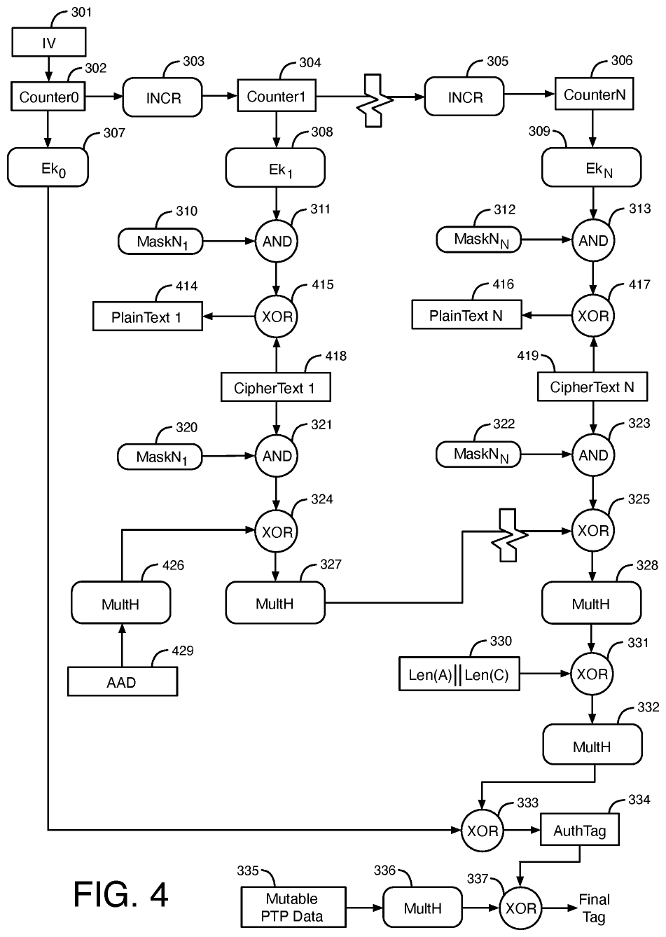

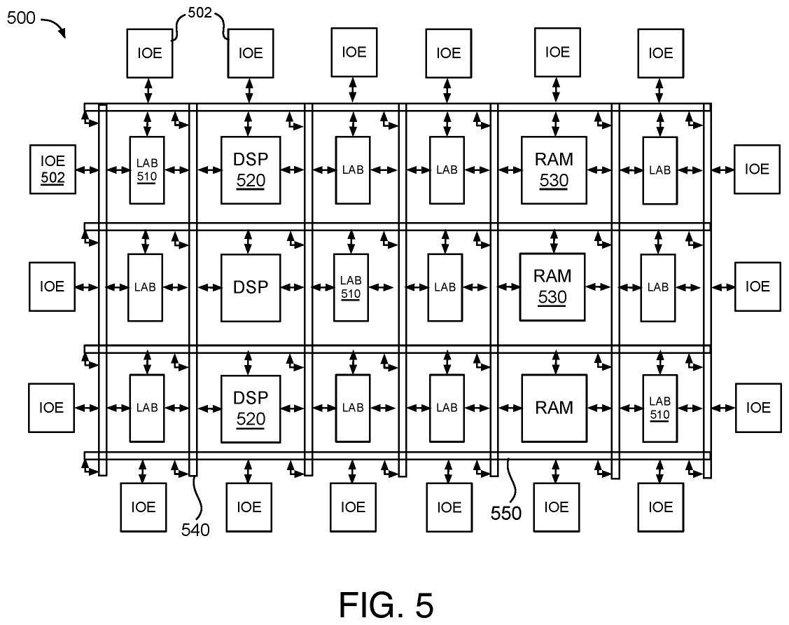

FIG. 4 is a flow chart that illustrates examples of operations that can be performed in the receiver circuit 110 to process secure PTP packets for MACsec according to an AES-GCM algorithm. In FIG. 4, operations 303, 305, 307-309, 311, and 313 using IV 301, counter blocks 302, 304, and 306, and mask values 310 and 312 are the same as described above with respect to FIG. 3. In FIG. 4, encrypted ciphertext fields CipherText1 418 and CipherTextN 419 are received by the MACsec circuit 111 as part of a PTP packet. The Ciphertext carries the PTP mutable field bits that are in PlainText and integrity protected by AES-GCM processing on transmit. Bitwise XOR Boolean logic functions 415 and 417 are performed on the CipherText blocks 418 and 419 and outputs of the AND Boolean functions 311 and 313 to generate plaintext PlainText1 414 to PlainTextN 416, respectively.

AND Boolean functions 321 and 323 mask out the PTP mutable field bits from CipherText1 418 and CipherTextN 419 to generate all zeros that are provided to XOR functions 324-325, respectively. In operation 426, additional authentication data (AAD) 429 is multiplied with the key-dependent constant H in the Galois field GF (2¹²⁸) to generate an output. The bitwise XOR Boolean function 324 is then performed on the output of the multiplication performed in operation 426 and the masked output of the AND Boolean function 321 to generate an output that is provided to operation 327. The bitwise XOR Boolean function 325 is performed on the output of the multiplication performed in operation 327 and the masked output of AND Boolean function 323 to generate an output. Multiplication operation 328, XOR function 331, multiplication operation 332, and XOR function 333 are performed as described above with respect to FIG. 3 to generate an authentication tag 334. The multiplication operation 336 and the XOR function 337 are also performed as described above with respect to FIG. 3 to generate a final authentication tag, which is compared to original ICV tag to qualify the received packet.

The PTP mutable field offsets can be fetched from the SAD, the PTP mutable fields from the offsets are read, and the post AAD algorithm is applied to verify the ICV. A multiplication function is used to process the post AAD data for reference. Each element is a vector of 128 bits. The i^{th}bit of an element X is denoted as Xᵢ. The leftmost bit is X₀, and the rightmost bit is X₁₂₇. The multiplication function uses the special element R=11100001∥0¹²⁰, and is defined in the following Algorithm. The function rightshift() moves the bits of its argument one bit to the right. More formally, whenever W=rightshift(V), then Wᵢ=Vᵢ₋₁ for 1≤i≤127 and W₀32 0.

The Algorithm for the multiplication in GF (2¹²⁸) is provided below. The Algorithm computes the value of Z=X·Y, where X, Y and Z ∈ GF(2¹²⁸).

Z ← 0, V ← X
for i = 0 to 127 do
if Yᵢ = 1 then
Z ← Z⊕V
end if
if V₁₂₇ = 0 then
V ← rightshift(V)
else
V ← rightshift(V) ⊕ R
end if
end for
return Z

FIG. 5 is a diagram that illustrates an example of a configurable logic integrated circuit (IC) 500 that can include, for example, circuitry and functions disclosed herein with respect to any, some, or all of FIGS. 1C-1D, 2, 3, or 4. As shown in FIG. 5, the configurable logic integrated circuit (IC) 500 includes a two-dimensional array of configurable functional circuit blocks, including configurable logic array blocks (LABs) 510 and other functional circuit blocks, such as random access memory (RAM) blocks 530 and digital signal processing (DSP) blocks 520. Functional blocks such as LABs 510 can include smaller programmable logic circuits (e.g., logic elements, logic blocks, or adaptive logic modules) that receive input signals and perform custom functions on the input signals to produce output signals.

In addition, programmable logic IC 500 can have input/output elements (IOEs) 502 for driving signals off of programmable logic IC 500 and for receiving signals from other devices. Input/output elements 502 can include parallel input/output circuitry, serial data transceiver circuitry, differential receiver and transmitter circuitry, or other circuitry used to connect one integrated circuit to another integrated circuit. As shown, input/output elements 502 can be located around the periphery of the chip. If desired, the programmable logic IC 500 can have input/output elements 502 arranged in different ways. For example, input/output elements 502 can form one or more columns, rows, or islands of input/output elements that may be located anywhere on the programmable logic IC 500.

The programmable logic IC 500 can also include programmable interconnect circuitry in the form of vertical routing channels 540 (i.e., interconnects formed along a vertical axis of programmable logic IC 500) and horizontal routing channels 550 (i.e., interconnects formed along a horizontal axis of programmable logic IC 500), each routing channel including at least one conductor to route at least one signal.

Note that other routing topologies, besides the topology of the interconnect circuitry depicted in FIG. 5, may be used. For example, the routing topology can include wires that travel diagonally or that travel horizontally and vertically along different parts of their extent as well as wires that are perpendicular to the device plane in the case of three dimensional integrated circuits. The driver of a wire can be located at a different point than one end of a wire.

Furthermore, it should be understood that embodiments disclosed herein can be implemented in any integrated circuit or electronic system. If desired, the functional blocks of such an integrated circuit can be arranged in more levels or layers in which multiple functional blocks are interconnected to form still larger blocks. Other device arrangements can use functional blocks that are not arranged in rows and columns.

Programmable logic IC 500 can contain programmable memory elements. Memory elements can be loaded with configuration data using input/output elements (IOEs) 502. Once loaded, the memory elements each provide a corresponding static control signal that controls the operation of an associated configurable functional block (e.g., LABs 510, DSP blocks 520, RAM blocks 530, or input/output elements 502).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that can be controlled in this way include multiplexers (e.g., multiplexers used for forming routing paths in interconnect circuits), look-up tables, logic arrays, AND, OR, XOR, NAND, and NOR logic gates, pass gates, etc.

The programmable memory elements can be organized in a configuration memory array having rows and columns. A data register that spans across all columns and an address register that spans across all rows can receive configuration data. The configuration data can be shifted onto the data register. When the appropriate address register is asserted, the data register writes the configuration data to the configuration memory bits of the row that was designated by the address register.

In certain embodiments, IC 500 can include configuration memory that is organized in sectors, whereby a sector can include the configuration RAM bits that specify the functions and/or interconnections of the subcomponents and wires in or crossing that sector. Each sector can include separate data and address registers.

The configurable logic IC of FIG. 5 is merely one example of an IC that can be used with embodiments disclosed herein. The embodiments disclosed herein can be used with any suitable integrated circuit or system. For example, the embodiments disclosed herein can be used with numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

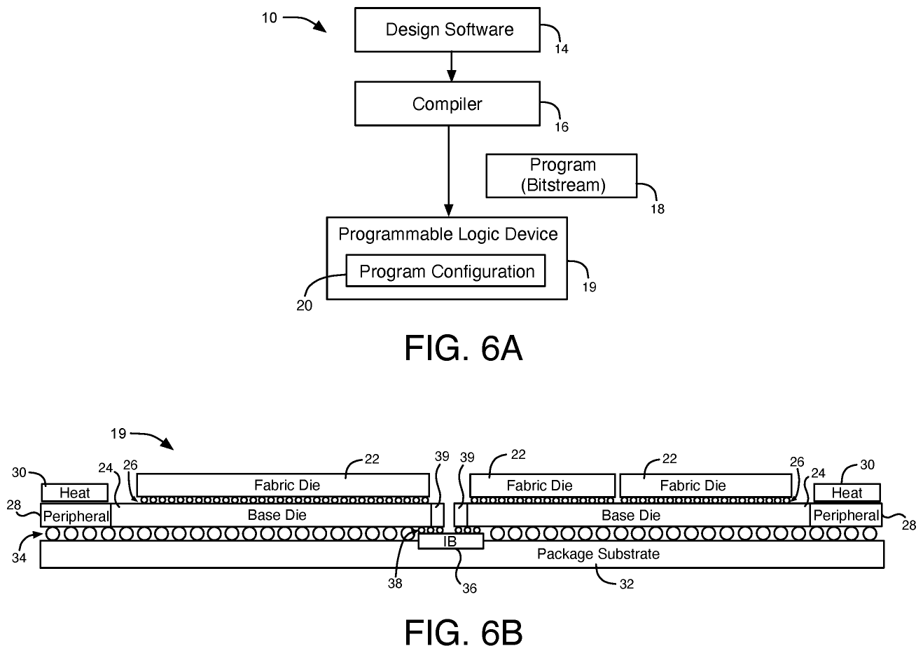

FIG. 6A illustrates a block diagram of a system 10 that can be used to implement a circuit design to be programmed into a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 6B, but many others can be used, and it should be understood that this disclosure is intended to encompass any suitable programmable logic device where programmable logic fabric and fabric support circuitry are at least partially separated on different integrated circuit die.

FIG. 6B is a diagram that depicts an example of the programmable logic device 19 that includes three fabric die 22 and two base die 24 that are connected to one another via microbumps 26. In the example of FIG. 6B, at least some of the programmable logic fabric of the programmable logic device 19 is in the three fabric die 22, and at least some of the fabric support circuitry that operates the programmable logic fabric is in the two base die 24. For example, some of the circuitry of configurable IC 500 shown in FIG. 5 (e.g., LABs 510, DSP 520, and RAM 530) can be located in the fabric die 22 and some of the circuitry of IC 500 (e.g., input/output elements 502) can be located in the base die 24.

Although the fabric die 22 and base die 24 appear in a one-to-one relationship or a two-to-one relationship in FIG. 6B, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 6B, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

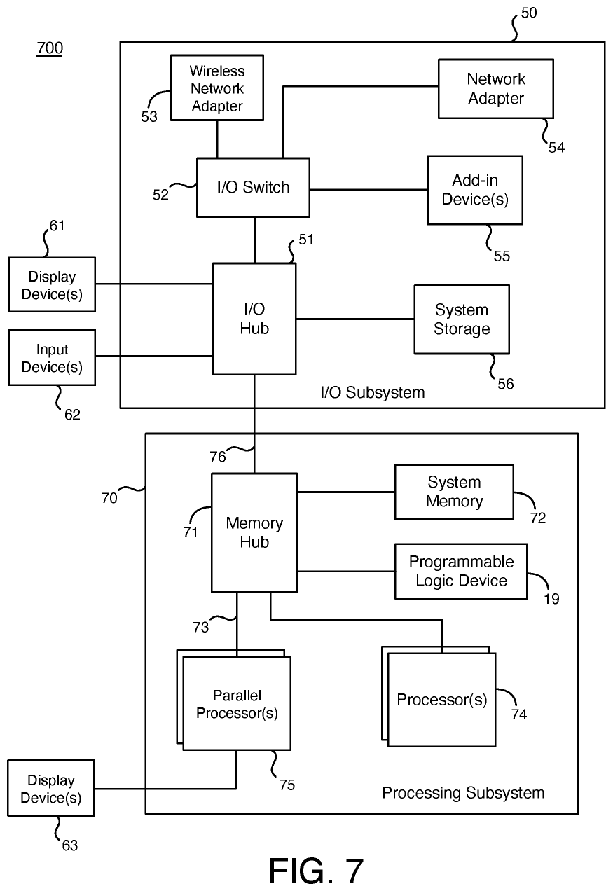

FIG. 7 is a block diagram illustrating a computing system 700 configured to implement one or more aspects of the embodiments described herein. The computing system 700 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 700 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 700. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 700 can include other components not shown in FIG. 7, including other port connections, optical storage drives, video capture devices, and the like, that can also be connected to the I/O hub 51. Communication paths interconnecting the various components in FIG. 7 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 700 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 700 can be integrated into a single package to form a system in package (SIP) configuration. In one embodiment, at least a portion of the components of the computing system 700 can be integrated into a multi-chip module (MCM), which can be interconnected with other multi-chip modules into a modular computing system.

The computing system 700 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 700. For example, any number of add-in cards or peripherals can be supported, or some components can be eliminated. Furthermore, some architectures can use different terminology for components similar to those illustrated in FIG. 7. For example, the memory hub 71 can be referred to as a Northbridge in some architectures, while the I/O hub 51 can be referred to as a Southbridge.

Additional examples are now described. Example 1 is a transmitter circuit comprising: a security circuit that masks mutable fields in a packet during an algorithm that generates an authentication tag for the packet; an extraction circuit that extracts the mutable fields from the packet to generate extracted fields; a calculation circuit that calculates updated values for the mutable fields using the extracted fields; and an inserter circuit that inserts the updated values for the mutable fields into the packet.

In Example 2, the transmitter circuit of Example 1 may optionally include, wherein the security circuit masks the mutable fields by zeroing the mutable fields as part of the algorithm that generates the authentication tag.

In Example 3, the transmitter circuit of any one of Examples 1-2 may optionally include, wherein the algorithm performed by the security circuit is an Advanced Encryption Standard in Galois/Counter Mode algorithm.

In Example 4, the transmitter circuit of any one of Examples 1-3 may optionally include, wherein the security circuit encrypts and generates the authentication tag for a Precision Time Protocol packet.

In Example 5, the transmitter circuit of any one of Examples 1-4 may optionally include, wherein the security circuit performs Media Access Control security in a layer of Open Systems Interconnect.

In Example 6, the transmitter circuit of any one of Examples 1-5 further comprising: a tag update circuit that inserts updated integrity check value tags into the packet received from the inserter circuit.

In Example 7, the transmitter circuit of any one of Examples 1-6 further comprises: a multiplexer circuit configurable to output the packet generated by the inserter circuit to enable single step Precision Time Protocol, wherein a timestamp is carried in a sync message.

In Example 8, the transmitter circuit of any one of Examples 1-7 further comprises: a cyclic redundancy check circuit that calculates cyclic redundancy check values and inserts the cyclic redundancy check values into the packet for transmission through a network.

In Example 9, the transmitter circuit of any one of Examples 1-8 further comprises: a timestamping unit circuit that generates a timestamp that the calculation circuit uses to calculate the updated values for the mutable fields.

Example 10 is a method for processing a packet by a transmitter circuit, the method comprising: performing an algorithm that generates an authentication tag for the packet by masking mutable fields in the packet using a security circuit; extracting the mutable fields from the packet to generate extracted fields using an extraction circuit; calculating updated values for the mutable fields using the extracted fields with a calculation circuit; and inserting the updated values for the mutable fields into the packet using an inserter circuit.

In Example 11, the method of Example 10 may optionally include, wherein performing the algorithm further comprises zeroing the mutable fields to generate zeroed fields and performing a Boolean function using the zeroed fields with the security circuit.

In Example 12, the method of any one of Examples 10-11 further comprises: inserting updated integrity check value tags into the packet received from the inserter circuit using a tag update circuit.

In Example 13, the method of any one of Examples 10-12 further comprises: configuring a multiplexer circuit to output the packet generated by the inserter circuit to enable single step Precision Time Protocol that carries a timestamp in a sync message.

In Example 14, the method of any one of Examples 10-13 further comprises: calculating cyclic redundancy check values using a cyclic redundancy check circuit; and inserting the cyclic redundancy check values into the packet for transmission through a network.

In Example 15, the method of any one of Examples 10-14 further comprises: generating a timestamp that the calculation circuit uses to calculate the updated values for the mutable fields using a timestamping circuit.

In Example 16, the method of any one of Examples 10-15 may optionally include, wherein the algorithm performed by the security circuit is an Advanced Encryption Standard in Galois/Counter Mode algorithm.

Example 17 a receiver circuit comprising: a security circuit that masks an encrypted mutable field received in a packet by replacing bits in the encrypted mutable field with zeroed bits, wherein the security circuit performs an algorithm that uses the zeroed bits to generate an authentication tag for the packet, wherein the security circuit uses offsets for the encrypted mutable field to bypass the encrypted mutable field for decryption, and wherein the security circuit decrypts additional encrypted fields received in the packet using the algorithm.

In Example 18, the receiver circuit of Example 17 may optionally include, wherein the security circuit comprises a post additional authenticated data processing stage that implements the algorithm to process the encrypted mutable field.

In Example 19, the receiver circuit of any one of Examples 17-18 may optionally include, wherein the security circuit compares a final integrity check value tag to an incoming integrity check value tag to declare a pass or fail condition for validation of the packet.

In Example 20, the receiver circuit of any one of Examples 17-19 may optionally include, wherein the algorithm performed by the security circuit uses Advanced Encryption Standard in Galois/Counter Mode.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. A transmitter circuit comprising:
a security circuit that masks mutable fields in a packet during an algorithm that generates an authentication tag for the packet;
an extraction circuit that extracts the mutable fields from the packet to generate extracted fields;
a calculation circuit that calculates updated values for the mutable fields using the extracted fields; and
an inserter circuit that inserts the updated values for the mutable fields into the packet.

2. The transmitter circuit of claim 1, wherein the security circuit masks the mutable fields by zeroing the mutable fields as part of the algorithm that generates the authentication tag.

3. The transmitter circuit of claim 1, wherein the algorithm performed by the security circuit is an Advanced Encryption Standard in Galois/Counter Mode algorithm.

4. The transmitter circuit of claim 1, wherein the security circuit encrypts and generates the authentication tag for a Precision Time Protocol packet.

5. The transmitter circuit of claim 1, wherein the security circuit performs Media Access Control security in a layer of Open Systems Interconnect.

6. The transmitter circuit of claim 1 further comprising:
a tag update circuit that inserts updated integrity check value tags into the packet received from the inserter circuit.

7. The transmitter circuit of claim 1 further comprising:
a multiplexer circuit configurable to output the packet generated by the inserter circuit to enable single step Precision Time Protocol, wherein a timestamp is carried in a sync message.

8. The transmitter circuit of claim 1 further comprising:
a cyclic redundancy check circuit that calculates cyclic redundancy check values and inserts the cyclic redundancy check values into the packet for transmission through a network.

9. The transmitter circuit of claim 1 further comprising:
a timestamping unit circuit that generates a timestamp that the calculation circuit uses to calculate the updated values for the mutable fields.

10. A method for processing a packet by a transmitter circuit, the method comprising:
performing an algorithm that generates an authentication tag for the packet by masking mutable fields in the packet using a security circuit;
extracting the mutable fields from the packet to generate extracted fields using an extraction circuit;
calculating updated values for the mutable fields using the extracted fields with a calculation circuit; and
inserting the updated values for the mutable fields into the packet using an inserter circuit.

11. The method of claim 10, wherein performing the algorithm further comprises zeroing the mutable fields to generate zeroed fields and performing a Boolean function using the zeroed fields with the security circuit.

12. The method of claim 10 further comprising:
inserting updated integrity check value tags into the packet received from the inserter circuit using a tag update circuit.

13. The method of claim 10 further comprising:
configuring a multiplexer circuit to output the packet generated by the inserter circuit to enable single step Precision Time Protocol that carries a timestamp in a sync message.

14. The method of claim 10 further comprising:
calculating cyclic redundancy check values using a cyclic redundancy check circuit; and
inserting the cyclic redundancy check values into the packet for transmission through a network.

15. The method of claim 10 further comprising:
generating a timestamp that the calculation circuit uses to calculate the updated values for the mutable fields using a timestamping circuit.

16. The method of claim 10, wherein the algorithm performed by the security circuit is an Advanced Encryption Standard in Galois/Counter Mode algorithm.

17. A receiver circuit comprising:
a security circuit that masks an encrypted mutable field received in a packet by replacing bits in the encrypted mutable field with zeroed bits, wherein the security circuit performs an algorithm that uses the zeroed bits to generate an authentication tag for the packet, wherein the security circuit uses offsets for the encrypted mutable field to bypass the encrypted mutable field for decryption, and wherein the security circuit decrypts additional encrypted fields received in the packet using the algorithm.

18. The receiver circuit of claim 17, wherein the security circuit comprises a post additional authenticated data processing stage that implements the algorithm to process the encrypted mutable field.

19. The receiver circuit of claim 17, wherein the security circuit compares a final integrity check value tag to an incoming integrity check value tag to declare a pass or fail condition for validation of the packet.

20. The receiver circuit of claim 17, wherein the algorithm performed by the security circuit uses Advanced Encryption Standard in Galois/Counter Mode.
